(19) United States
(12) Patent Application Publication
(10) Pub. No.: US 2026/0042301 A1
(43) Pub. Date: Feb. 12, 2026

(54) SHEET CONVEYING DEVICE AND IMAGE FORMING SYSTEM

(71) Applicants: Hirotaka YASUKAWA, Kanagawa (JP); Shuuto TOHKAISHI, Kanagawa (JP); Yuusuke SHIBASAKI, Kanagawa (JP); Atsushi SHINODA, Kanagawa (JP); Sho ASANO, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Naohiro YOSHIDA, Kanagawa (JP); Yoshito SUZUKI, Kanagawa (JP); Shinya MONMA, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Ryota TAKAYAMA, Kanagawa (JP); Wataru TAKAHASHI, Kanagawa (JP)

(72) Inventors: Hirotaka YASUKAWA, Kanagawa (JP); Shuuto TOHKAISHI, Kanagawa (JP); Yuusuke SHIBASAKI, Kanagawa (JP); Atsushi SHINODA, Kanagawa (JP); Sho ASANO, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Naohiro YOSHIDA, Kanagawa (JP); Yoshito SUZUKI, Kanagawa (JP); Shinya MONMA, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Ryota TAKAYAMA, Kanagawa (JP); Wataru TAKAHASHI, Kanagawa (JP)

(73) Assignee: Ricoh Company, Ltd., Tokyo (JP)

(21) Appl. No.: 19/279,442

(22) Filed: Jul. 24, 2025

(30) Foreign Application Priority Data
Aug. 8, 2024 (JP) 2024-132117

(51) Int. Cl. B41J 11/00; B41J 13/32; G03G 15/00

(52) U.S. Cl. CPC B41J 11/0095; B41J 11/0015; B41J 13/32; G03G 15/6567; G03G 15/6582; G03G 2215/00721

(57) ABSTRACT

A sheet conveying device includes conveyors, a skew detector, a mover, and circuitry. The conveyors convey a sheet medium in a first direction. The skew detector detects an amount of skew of the sheet medium conveyed by the conveyors in the first direction. The mover moves the skew detector in a second direction orthogonal to the first direction. The circuitry is to control the mover to move the skew detector in the second direction to detect, multiple times, an end of the sheet medium in the second direction at a detection interval, and change the detection interval of multiple detections according to a size of the sheet medium, to detect the amount of skew of the sheet medium.

### CROSS-REFERENCE TO RELATED APPLICATION

This patent application is based on and claims priority pursuant to 35 U.S.C. § 119 (a) to Japanese Patent Application No. 2024-132117, filed on Aug. 8, 2024, in the Japan Patent Office, the entire disclosure of which is hereby incorporated by reference herein.

### BACKGROUND

### Technical Field

Embodiments of the present disclosure relate to a sheet conveying device and an image forming system incorporating the sheet conveying device.

### Background

Various types of sheet conveying devices are known that convey a sheet medium. Further, various types of image forming systems are known that include a sheet processing apparatus including a sheet conveying device and performing a predetermined process on a medium or that are installable of a sheet processing apparatus including a sheet conveying device in the in-body portion to perform a predetermined process on a medium on which an image is formed.

When a sheet-like medium is conveyed in a sheet conveying device, the medium is likely to incline (skew) in a conveyance direction of the medium. For the purpose of deskewing the medium, a configuration or structure has been disclosed that calculates an appropriate correction amount based on the skew amount and deskew the medium efficiently.

A sheet conveying device in the art has a configuration in which a skew is detected regardless of the size of a medium as a conveyance target. For this reason, when the size of the medium is relatively large or small, there is an issue that the skew detection accuracy with respect to various sizes of media decreases in a skew detection based on a predetermined medium size.

### SUMMARY

Embodiments of the present disclosure described herein provide a novel sheet conveying device including conveyors, a skew detector, a mover, and circuitry. The conveyors convey a sheet medium in a first direction. The skew detector detects an amount of skew of the sheet medium conveyed by the conveyors in the first direction. The mover moves the skew detector in a second direction orthogonal to the first direction. The circuitry is to control the mover to move the skew detector in the second direction to detect, multiple times, an end of the sheet medium in the second direction at a detection interval, and change the detection interval of multiple detections according to a size of the sheet medium, to detect the amount of skew of the sheet medium.

Further, embodiments of the present disclosure described herein provide an image forming system including an image forming apparatus that includes a housing, an image forming device included in the housing to form an image on a sheet medium, and the above-described the sheet conveying device detachably attached to the housing to convey the sheet medium having the image formed by the image forming device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view of an example of a printing system as an image forming system according to an embodiment of the present disclosure;

FIG. 2 is an external view of an example of a printing system as an image forming system according to an embodiment of the present disclosure;

FIG. 3A is a diagram illustrating an example of a structure of a printing system according to an embodiment of the present disclosure;

FIG. 3B is a diagram illustrating an example of a functional block of a printing system according to an embodiment of the present disclosure of FIG. 3A;

FIG. 4A is a diagram illustrating an example of a structure of a printing system according to an embodiment of the present disclosure;

FIG. 4B is a diagram illustrating an example of a functional block of a printing system according to an embodiment of the present disclosure of FIG. 4A;

FIG. 5 is a diagram illustrating a control configuration of a sheet processing unit according to an embodiment of the present disclosure;

FIG. 6 is a cross sectional view of a sheet processing unit according to the present embodiment;

FIG. 7 is a diagram illustrating an operation process of a sheet processing unit according to the present embodiment;

FIG. 8 is a diagram illustrating an operation process of a sheet processing unit according to the present embodiment;

FIG. 9 is a diagram illustrating an operation process of a sheet processing unit according to the present embodiment;

FIG. 10 is a diagram illustrating an operation process of a sheet processing unit according to the present embodiment;

FIG. 11 is a diagram illustrating an operation process of a sheet processing unit according to the present embodiment;

FIG. 12 is a cross sectional diagram illustrating a lateral registration detector according to the present embodiment;

FIG. 13 is a diagram illustrating a skew detecting operation according to the present embodiment;

FIG. 14 is a diagram illustrating a table of data configuration indicating an example of sheet information according to the present embodiment;

FIG. 15 is a diagram illustrating a sampling error in a skew detecting operation according to the present embodiment;

FIG. 16 is a diagram illustrating a skew amount in a skew detecting operation according to the present embodiment;

FIG. 17 is a diagram illustrating a sheet binder according to the present embodiment, performing an operation process;

FIG. 18 is a diagram illustrating a sheet binder according to the present embodiment, performing an operation process subsequent to the operation process in FIG. 17;

FIG. 19 is a diagram illustrating a sheet binder according to the present embodiment, performing an operation process subsequent to the operation process in FIG. 18;

FIGS. 20A and 20B are diagrams illustrating a sheet binder according to the present embodiment, performing an operation process subsequent to the operation process in FIG. 19;

FIG. 21 is a diagram illustrating a sheet binder according to the present embodiment, performing an operation process subsequent to the operation process in FIGS. 20A and 20B;

FIGS. 22A and 22B are diagrams illustrating a sheet binder according to the present embodiment, performing a skew correction operation in the sheet binder;

FIG. 23 is a diagram illustrating a coupling of a sheet processing unit according to the present embodiment and an external device;

FIG. 24 is a diagram illustrating a coupling operation process of a sheet processing unit according to the present embodiment and an external device; and

FIG. 25 is a diagram illustrating a schematic configuration of a punching unit according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Embodiments of a sheet conveying device and an image forming system according to the present disclosure are described with reference to the drawings.

A sheet conveying device according to the present disclosure to be described below is an example of a device included in a sheet processing unit 100. The sheet conveying device has a function of moving a sheet S that is a sheet-like medium in a predetermined direction along a conveyance path. The sheet processing unit 100 has a function to execute a predetermined process on a sheet S that has been moved by the sheet conveying device.

### Embodiment of Image Forming System

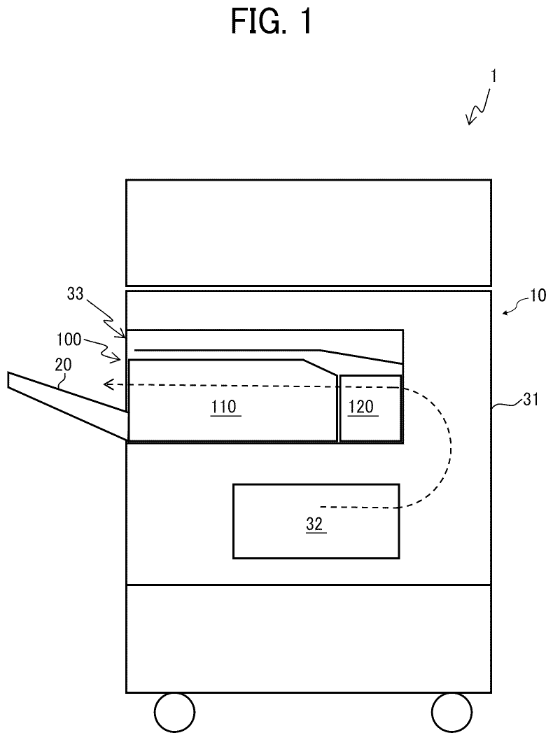

FIG. 1 is an external view of a printing system 1 as an image forming system according to an embodiment of the present disclosure.

The printing system 1 is an apparatus having an image forming function of forming an image on a sheet S (typically, a paper sheet) as a sheet-like medium, and a sheet processing function of executing a predetermined sheet processing (post-processing) on the sheet S on which the image is formed (recorded).

As illustrated in FIG. 1, the printing system 1 includes an image forming apparatus including a housing 31 and an image forming device 32 disposed in the housing 31. The housing 31 of the image forming apparatus 10 has a box-shaped member having an inner space to accommodate the components of the printing system 1. The housing 31 has an in-body space 33 that is accessible from the outside of the printing system 1. The in-body space 33 is located, for example, slightly above the center of the housing 31 in the vertical direction. The in-body space 33 is exposed to the outside through the cutting that is made by cutting out the outer wall of the housing 31.

Further, a sheet processing unit 100 is attachable to the in-body space 33. The sheet processing unit 100 functions as a sheet processing apparatus according to an embodiment of the present disclosure. A sheet processing unit 100 illustrated in FIG. 1 includes a sheet binder 110 and a hole puncher 120. The sheet binder 110 performs a “sheet binding operation” to bundle and bind sheets S. The hole puncher 120 performs a “punching operation” to make a hole (opening) in the sheets S. The sheet processing unit 100 may include the sheet binder 110 and the hole puncher 120 as separate units disposed away from each other.

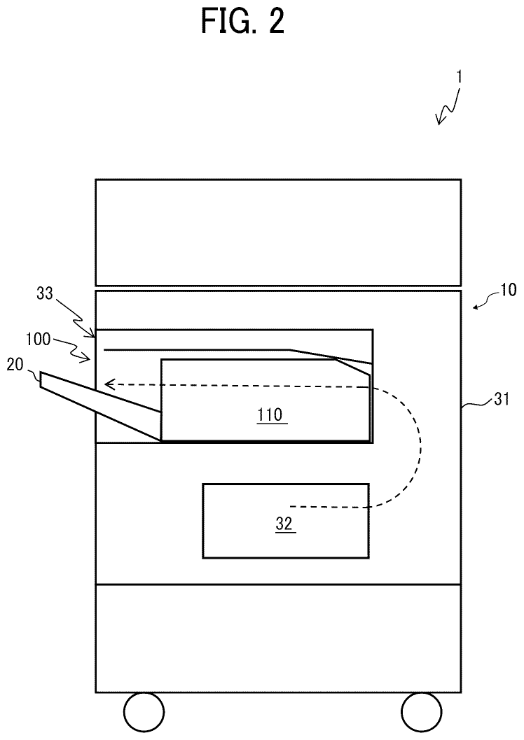

For example, FIG. 2 is an external view of an example of the printing system 1 according to an embodiment of the present disclosure.

As illustrated in FIG. 2, the sheet processing unit 100 may include the sheet binder 110 only.

In the following description of the present disclosure, the sheet processing unit 100 includes the sheet binder 110 and the hole puncher 120 as a single unit attached to the sheet processing unit 100.

Referring back to FIG. 1, the description is given of the printing system 1. The image forming device 32 of the image forming apparatus 10 forms an image on a sheet S that is picked up from a sheet tray and conveyed by multiple conveyors including multiple conveyance roller pairs. The sheet S conveyed from the image forming device 32 is further conveyed to the hole puncher 120 and the sheet binder 110 in this order. The image forming device 32 may be an inkjet image forming device that forms an image with ink or an electrophotographic image forming device that forms an image with toner. Since the image forming device 32 has a typical configuration, a detailed description of the image forming device 32 will be omitted unless otherwise required.

The hole puncher 120 is disposed in the in-body space 33 of the printing system 1 and is located downstream from the image forming device 32 and upstream from the sheet binder 110 in a conveyance path of the sheet S from the image forming device 32 to the sheet processing unit 100. The conveyance path is indicated by a dashed line and an arrow in FIG. 1. In other words, the sheet S on which an image is formed by the image forming device 32 is firstly conveyed to the hole puncher 120 where a given punching operation. Then, the sheet S is conveyed to the sheet binder 110 where a sheet binding operation in which a sheet bundle Sb including multiple sheets S bundled together is bound.

In the following description, as a configuration for executing conveyance (movement) of the sheet S, the printing system 1 and the sheet processing unit 100 are both provided with a conveying device that includes a conveyance roller pair or conveyance roller pairs, a drive source to drive the conveyance roller pair(s), and a controller to control the operation of the drive source.

The hole puncher 120 is detachably attached to the printing system 1.

When the hole puncher 120 is removed, as illustrated in FIG. 2, the sheet S having an image formed by the image forming device 32 is directly conveyed to the sheet binder 110 so that the sheet binding operation is performed on the sheet S. Another processing unit that performs a given process on the sheet S may be disposed in the in-body space 33 at the position from which the hole puncher 120 is removed.

### Embodiment of Control Configuration

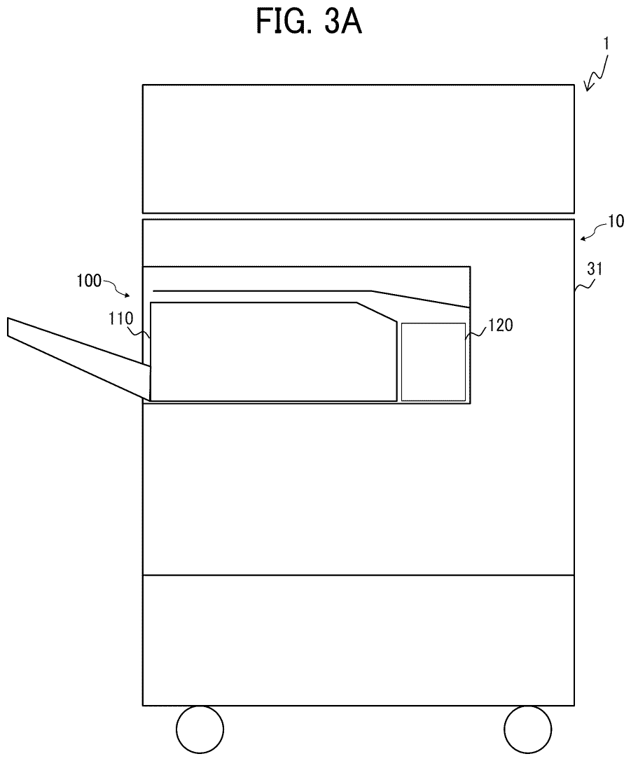

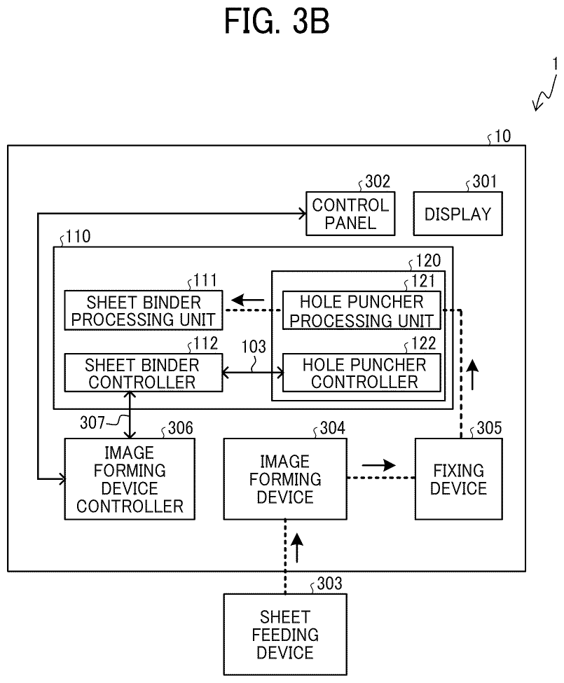

FIG. 3A is a diagram illustrating an example of a structure of the printing system 1 according to an embodiment of the present disclosure, where the hole puncher 120 is attached to the printing system 1.

FIG. 3B is a diagram illustrating an example of the functional block of the control configuration of the printing system 1 according to an embodiment of the present disclosure of FIG. 3A.

In FIGS. 3A and 3B, a conveyance path of the sheet S (flow of the sheet S) defined by the conveyors is indicated by an arrow in a broken line, and a path (flow of signals) of a communication signal (control signal) is indicated by an arrow in a solid line.

The printing system 1 includes a display 301, a control panel 302, and a sheet feeding device 303. The display 301 notifies the user of the state of various devices and the operation contents of the image forming system 1. The control panel 302 allows the user to set, for example, an operation mode and the number of copies. The sheet feeding device 303 stocks sheets S and feeds the sheets S one by one. The printing system 1 further includes an image forming unit 304 and a fixing device 305. The image forming unit 304 forms a latent image on a photoconductor and transfers the image to the sheet S. The fixing device 305 fixes the image transferred onto the sheet S. The printing system 1 further includes an image forming device controller 306 that controls various operations of the devices and units described above.

In the sheet binder 110, the image forming device controller 306 of the printing system 1 instructs a sheet binder controller 112, through a communication line 307, to execute a process, so that a sheet binder processing unit 111 executes the designated process on a designated sheet S. Designated information of process contents on the sheet S from the image forming device controller 306 is notified to a hole puncher processing unit 121 via the sheet binder processing unit 111.

The image forming device controller 306 and the sheet binder controller 112 are connected to each other via the communication line 307 to exchange information between the image forming device controller 306 and the sheet binder controller 112. By so doing, information on, for example, the operation mode, the size of the sheet S, and the timing are exchanged to make the system operable.

In the hole puncher 120, an instruction is given from the image forming device controller 306 of the printing system 1 to the sheet binder controller 112 through a communication line 307 and from the sheet binder controller 112 to a hole puncher controller 122 through a communication line 103. The hole puncher controller 122 controls the hole puncher processing unit 121 to perform a designated punching operation.

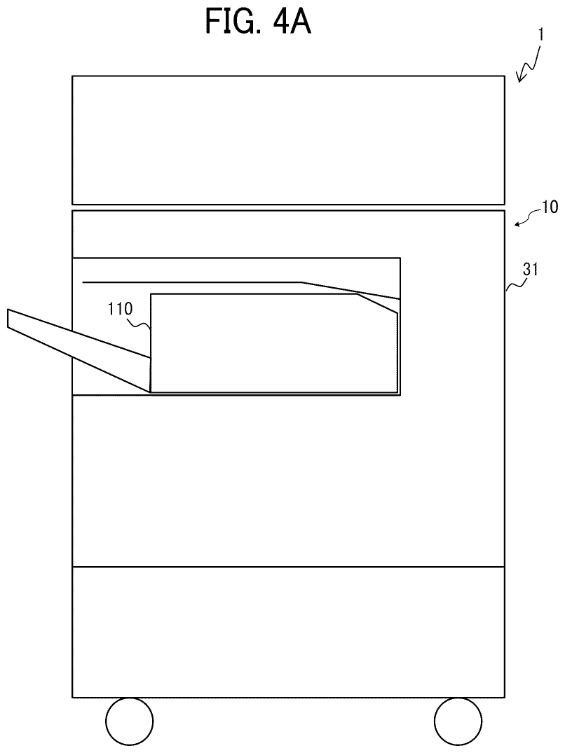

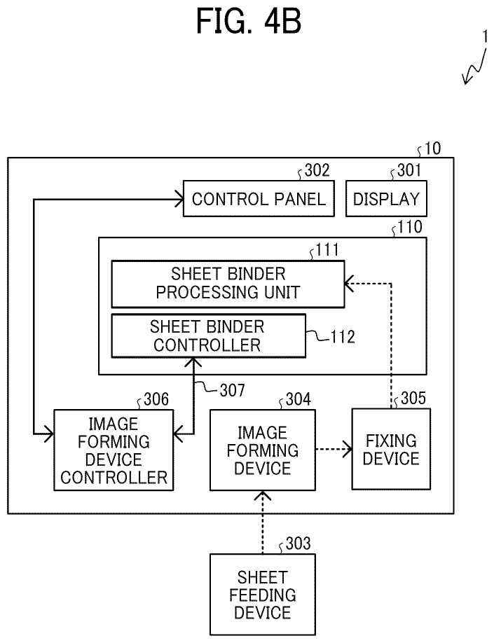

FIG. 4A is a diagram illustrating an example of a structure of the printing system 1 according to an embodiment of the present disclosure, where the hole puncher 120 is detached from the printing system 1 that includes the sheet processing unit 100.

FIG. 4B is a diagram illustrating an example of the functional block of the control configuration of the printing system 1 according to an embodiment of the present disclosure of FIG. 4A.

The printing system 1 illustrated in FIGS. 4A and 4B has the same configuration as the printing system 1 illustrated in FIGS. 3A and 3B, and includes the display 301, the control panel 302, the sheet feeding device 303, the image forming unit 304, and the image forming device controller 306.

In the printing system 1 illustrated in FIGS. 4A and 4B, the image forming device controller 306 of the printing system 1 instructs the sheet binder controller 112, through the communication line 307, to execute a process, so that the sheet binder processing unit 111 executes the designated process on a designated sheet S.

The image forming device controller 306 and the sheet binder controller 112 are connected to each other via the communication line 307 to exchange information between the image forming device controller 306 and the sheet binder controller 112. By so doing, information on, for example, the operation mode, the size of the sheet S, and the timing are exchanged to make the system operable.

### Hardware Configuration of Printing System 1

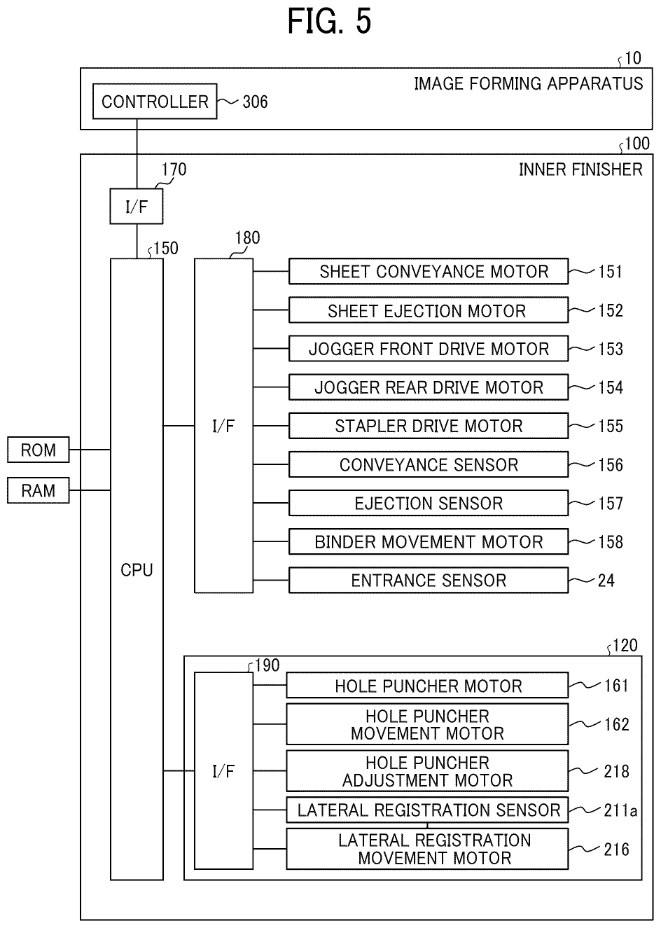

A description is given below of a hardware configuration of the sheet binder 110 of the sheet processing unit 100 included in the printing system 1, with reference to FIG. 5.

FIG. 5 is a diagram illustrating a control configuration of the sheet processing unit 100 according to an embodiment of the present disclosure.

As illustrated in FIG. 5, the sheet processing unit 100 includes a central processing unit (CPU) 150 as a controller, and is connected to multiple motors as power sources for operating various mechanisms via an interface (I/F) 170. The CPU 150 is a calculation unit and controls the entire operation of the sheet binder 110.

The CPU 150 in the sheet binder 110 is connected to the image forming device controller 306 of the printing system 1 via the I/F 170 to control the sheet binder 110 in accordance with a processing signal from the printing system 1. Since the sheet binder 110 is also an optional device, the hardware of the sheet binder 110 is detachable from the printing system 1.

Each of the drive motors has an encoder to detect the amount of driving force of the drive motor by the number of pulses, so that the drive motor can stop at the position of a specific amount of driving force starting from a specific timing. Further, the amount of driving force of each of the drive motors is measured based on the encoder pulse with the timing at which the sensor on the conveyance path is on or off as a base point, and the position of the end of the sheet S being conveyed can be detected based on the driving amount.

As illustrated in FIG. 5, in the sheet binder 110, a sheet conveyance motor 151, a sheet ejection motor 152, a jogger front drive motor 153, a jogger rear drive motor 154, a stapler drive motor 155, a conveyance sensor 156, an ejection sensor 157, a binder movement motor 158, and an entrance sensor 24 are connected to the CPU 150 via an interface (I/F) 180.

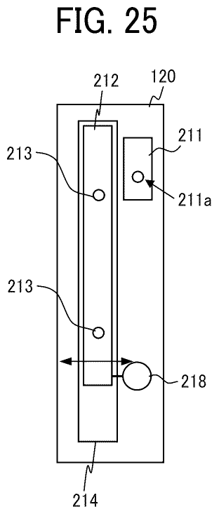

Further, in the hole puncher 120, a hole puncher motor 161, a hole puncher movement motor 162, a hole puncher adjustment motor 218 (see FIG. 25), a lateral registration sensor 211a, and a lateral registration movement motor 216 are connected to the CPU 150 via an interface (I/F) 190.

### Configuration of Conveyance Path of Sheet Processing Unit 100

A description is given below of a configuration of the conveyance path of a sheet S included in the sheet processing unit 100 as a sheet processing apparatus according to an embodiment of the present disclosure.

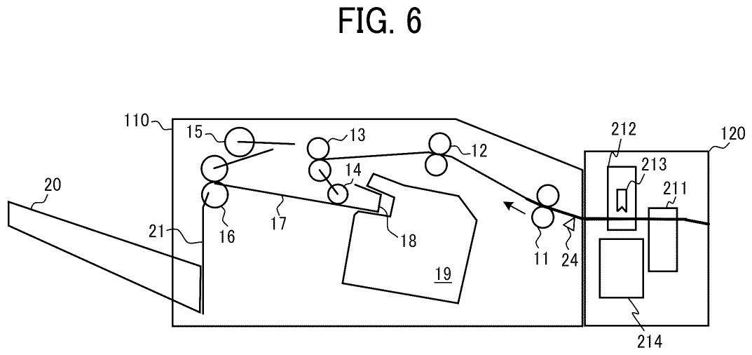

FIG. 6 is a cross sectional view of a conveyance path of the sheet processing unit 100 according to an embodiment of the present disclosure.

The sheet processing unit 100 is settable with multiple operation modes and executes an operation control by the sheet binder controller 112 based on the set operation mode.

The sheet processing unit 100 according to the present embodiment will be described on the premise that the sheet processing unit 100 is disposed in the printing system 1 described above and the sheet binder 110 and the hole puncher 120 are combined.

The sheet S on which an image is formed by the image forming device 32 is conveyed into the hole puncher 120 by the conveyors of the sheet conveying device. The direction of conveyance of the sheet S at this time is referred to as a first direction. The sheet S conveyed in the first direction passes through the hole puncher 120 to be conveyed to the entrance roller pair 11 of the sheet binder 110. The hole puncher 120 includes the lateral registration detector 211 that is described below. The lateral registration detector 211 includes a mechanism to move in a second direction that is orthogonal to the first direction. When the first direction is the length direction of the sheet S, the second direction corresponds to the width direction of the sheet S. In the following description, the first direction may be referred to as a “length direction”, and the second direction may be referred to as a “width direction”.

When the sheet S passes through the hole puncher 120, the lateral registration detector 211 detects the end portion of the sheet S in the second direction (the end portion in the width direction), and the punching device 212, which is described below, is moved in accordance with the position of the detected end portion in the width direction. In other words, the hole puncher 120 includes the punching device 212 that moves the position of forming a punch hole according to the detection result of the lateral registration detector 211. Since the hole puncher 120 includes a conveyor including a conveyance roller pair, the conveyor is stopped at the position at which the punching operation can be performed on the sheet S. Then, punch holes are formed by punching pins 213 in the punching device 212, on the sheet S whose conveyance is stopped. The punch chads in the punching operation fall into a punch chads hopper 214 to be stored. The sheet S is conveyed again after the punch holes are formed, so that the process in the sheet binder 110 is further executed.

As illustrated in FIG. 6, the hole puncher 120 includes a lateral registration detector 211 and a punching device 212. The lateral registration detector 211 moves in the width direction and detects the end portion of the sheet S in the width direction. The punching device 212 moves in the width direction and aligns the punching pins 213 according to the detected positions of the end portion of the sheet S in the width direction.

Each of the punching pins 213 is a member that penetrates the sheet S and forms a punch hole.

The punch chads hopper 214 accumulates punch chads generated by forming punching holes by the hole puncher 120.

Although not all are illustrated in FIG. 6, the hole puncher 120 further includes a lateral registration sensor drive belt punch hopper 215, the lateral registration movement motor 216, a lateral registration sensor moving belt 217, and the hole puncher adjustment motor 218.

The lateral registration sensor drive belt punch hopper 215 accumulates punch chads generated by forming punching holes by the hole puncher 120. The lateral registration movement motor 216 is a drive source to move the lateral registration detector 211 in the width direction. The lateral registration sensor moving belt 217 is a belt that conveys the driving force of the lateral registration movement motor 216 to the lateral registration detector 211. The hole puncher adjustment motor 218 is a drive source that moves the position of the punching pins 213 and changes the position of the punching pins 213 on the sheet S in the hole puncher 120.

The sheet binder 110 is selectively settable with an operation mode, specifically, any one of a shift ejection mode and a staple binding mode. In the present embodiment, the sheet binder 110 is provided with the stapler 19. However, a crimper that performs a crimp binding operation without using any staple may be provided to the sheet binder 110 or both the stapler 19 and the crimper may be provided to the sheet binder 110.

When the sheet binder 110 is set to the shift ejection mode, the entrance sensor 24 detects the sheet S conveyed from the printing system 1, and the entrance roller pair 11 that is one of the conveyors rotates to receive the sheet S. After being conveyed to the ejection roller pair 16 by the entrance roller pair 11, the conveyance roller pair 12, and the shift roller pair 13, the sheet S is ejected to the ejection tray 20. The entrance roller pair 11, the conveyance roller pair 12, the shift roller pair 13, and the ejection roller pair 16 are included in a first conveyor. In other words, when the sheet S is conveyed from the entrance roller pair 11 toward the ejection roller pair 16, the conveyance direction corresponds to the first direction.

When the sheet binder 110 is set to the staple binding mode, the sheet S conveyed from the printing system 1 is received by the entrance roller pair 11, is conveyed to the shift roller pair 13 in the first direction, and passes through the shift roller pair 13. Then, a tapping roller 15 is driven to place the sheet S on a sheet tray 17 as an internal tray. Then, as the tapping roller 15 and the return roller 14 rotate, the sheet S is conveyed in a third direction that is an opposite direction to the first direction. The third direction corresponds to a direction opposite to the first direction. The conveyance in the third direction at this time corresponds to a “switchback conveyance” that is a conveyance toward a reference fence 18 to align the end of the sheet S. The tapping roller 15 and the return roller 14 are included in a switchback conveyor to convey the sheet S in the third direction.

In the staple binding mode, the above-described conveyance of the sheet S in the third direction (the operation from the sheet tray 17 to the reference fence 18) is repeated until the number of sheets S reaches the number of sheets to be bound. When the last sheet S is conveyed to the reference fence 18, for example, the stapler 19 performs the stapling process in which a staple (or staples) penetrate the end of a bundle of sheets S (sheet bundle Sb). The bound sheet bundle Sb is conveyed in the first direction by the ejection roller pair 16 as a conveyor and is ejected to the ejection tray 20.

The sheet S or the sheet bundle Sb ejected to the ejection tray 20 is aligned by contacting an end of the sheet S or the sheet bundle Sb against an end fence 21.

### First Embodiment of Sheet Processing Unit 100

A description is given below of a skew detecting operation performed in the sheet processing unit 100, according to an embodiment of the present disclosure.

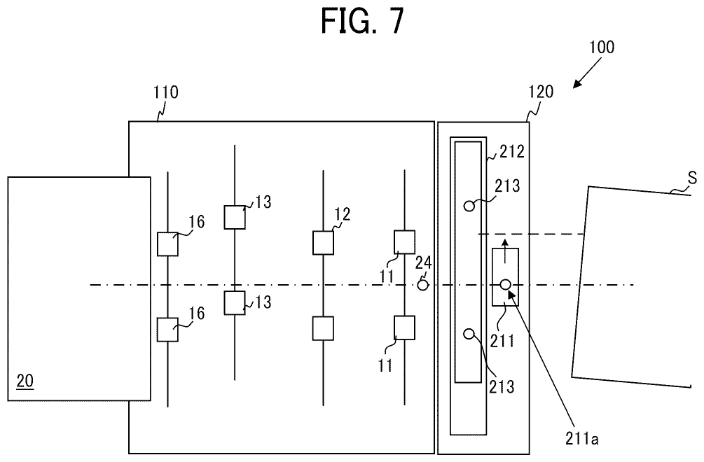

FIG. 7 is a diagram illustrating an operation process in a state before the sheet S is inserted into the hole puncher 120.

In this state, the lateral registration detector 211 is standing by at the center of the conveyance path.

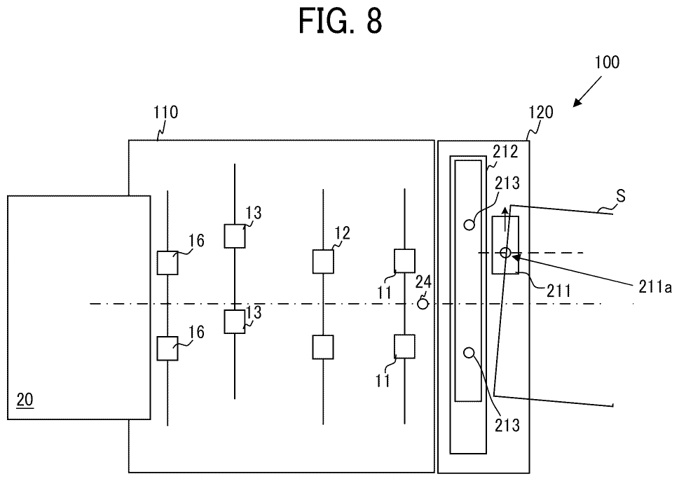

Subsequently, FIG. 8 is a diagram illustrating an operation process of the sheet processing unit 100 according to the present embodiment.

As illustrated in FIG. 8, when the sheet S is inserted into the hole puncher 120, the lateral registration sensor 211a mounted on the lateral registration detector 211 moves from the center position of the conveying path in the direction (second direction) orthogonal to the conveyance direction of the sheet S. The position of the lateral registration sensor 211a at this time is set according to the size of the sheet S, and is set to a position corresponding to one fourth of the size of the sheet S in the width direction. The lateral registration detector 211 stands by at the standby position until the end portion of the sheet S in the conveyance direction is detected.

The standby position of the lateral registration detector 211 is determined based on the size of the sheet S, more specifically, the dimension of the sheet S in the width direction. The information (sheet information) on the size of the sheet S is notified in advance from the image forming device controller 306 to the sheet binder controller 112. In other words, the sheet processing unit 100 identifies the dimension in the width direction of the sheet S to be inserted into the hole puncher 120 in advance, and the hole puncher controller 122 controls the movement of the lateral registration detector 211 based on the sheet information as the medium information.

The lateral registration detector 211 detects the state where the sheet S is conveyed, the leading end of the sheet S, and the trailing end of the sheet S, using the lateral registration sensor 211a. For this reason, the lateral registration detector 211 is to quickly move to the standby position after the sheet S is conveyed and before the lateral registration sensor 211a detects the leading end of the sheet S in the conveyance direction. Accordingly, at the time of acquiring the sheet information before detecting the conveyance of the sheet S, the lateral registration detector 211 moves from the center of the conveyance path of the sheet S to the position shifted by the distance by one-fourth the size of the sheet S in the width direction and stands by until a detection of the sheet S.

As illustrated in FIG. 8, after the sheet S is conveyed and the lateral registration sensor 211a of the lateral registration detector 211 detects the leading end of the sheet S, the lateral registration sensor 211a is moved to a position for detecting the end portion of the sheet S in the width direction in the conveyance direction. In other words, the lateral registration detector 211 is moved in the second direction.

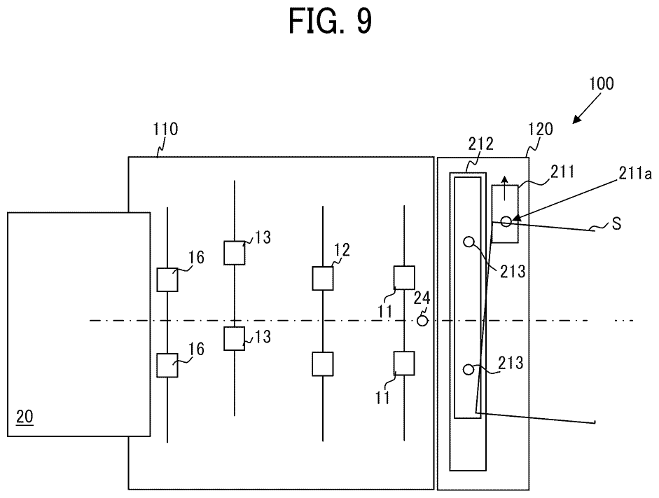

Subsequently, FIG. 9 is a diagram illustrating an operation process of the sheet processing unit 100 according to the present embodiment.

As illustrated in FIG. 9, the lateral registration detector 211 moves in the second direction to detect the end portion of the sheet S in the width direction. The end portion of the sheet S in the width direction to be detected at this time by the lateral registration detector 211 is a position near the leading end of the sheet S in the conveyance direction (near the leading end portion). In this detection, the lateral registration detector 211 detects the end portion of the sheet S in the width direction while moving to the sheet S.

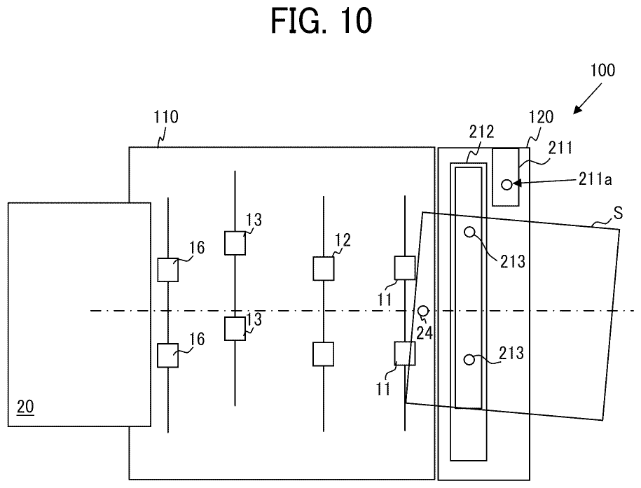

Subsequently, FIG. 10 is a diagram illustrating an operation process of the sheet processing unit 100 according to the present embodiment.

As illustrated in FIG. 10, after detecting the end portion in the width direction near the leading end of the sheet S, the lateral registration detector 211 moves to a retracted position. The reason why the lateral registration sensor 211a is retracted after the end portion in the width direction near the leading end of the sheet S is detected is to locate the lateral registration sensor 211a at the position where the lateral registration sensor 211a does not detect the sheet S until the end portion in the width direction near the trailing end of the sheet S is detected, so as to deskew the sheet S even if the direction of the skew is any direction.

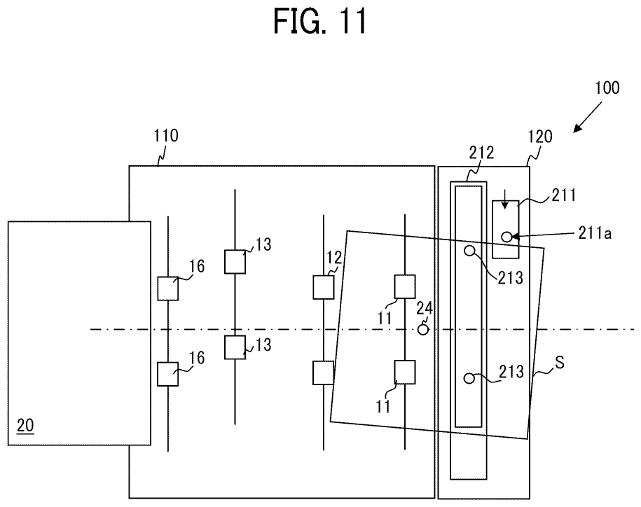

Subsequently, FIG. 11 is a diagram illustrating an operation process of the sheet processing unit 100 according to the present embodiment.

As illustrated in FIG. 11, in order to detect the end portion in the width direction of the sheet S near the trailing end of the sheet S in the conveyance direction of the sheet S, the sheet binder controller 112 manages the conveyance amount from a detection of the end portion in the width direction of the sheet S near the leading end of the sheet S. Then, the sheet binder controller 112 causes the lateral registration detector 211 to move in the second direction to detect the end portion in the width direction of the sheet S near the trailing end of the sheet S according to the size information of the sheet S, so as to detect the end portion in the width direction of the sheet S.

As described above, the lateral registration detector 211 is moved in advance to the standby position according to the conveyance timing of the sheet S, so that the lateral registration detector 211 detects the end portion in the width direction of the sheet S near the leading end of the sheet S. In this detection, the lateral registration detector 211 detects the end portion in the width direction of the sheet S while being moved in the second direction. After the end portion in the width direction of the sheet S near the leading end of the sheet S is detected, the lateral registration detector 211 is temporarily moved to the retracted position, and is started to move from the standby position to detect the end portion of the sheet S in the width direction near the trailing end of the sheet S according to the conveyance amount of the sheet S. Then, the lateral registration detector 211 detects the end portion of the sheet S in the width direction again while being moved in the second direction, so as to detect the end portion of the sheet S in the width direction near the trailing end of the sheet S.

By the above detection, the position in the second direction of the end portion in the width direction of the sheet S conveyed in the first direction can be acquired at two positions near the leading and trailing ends in the conveyance direction of the sheet S. The number of positions is not limited to two, and the movement of the lateral registration detector 211 in the second direction and the detection operation may be repeated by a further number of times (multiple times) so as to detect the end portion of the sheet S in the width direction.

### Embodiment of Lateral Registration Detector 211

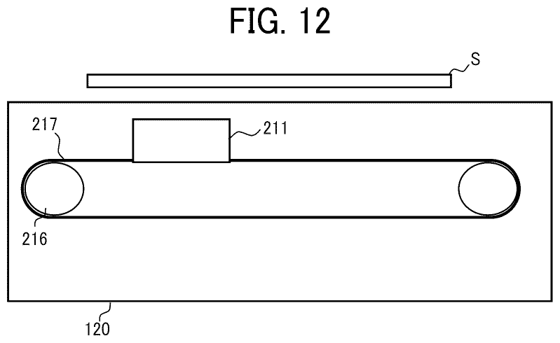

FIG. 12 is a cross sectional diagram illustrating the lateral registration detector 211 as a skew detector, according to the present embodiment, viewed in the conveyance direction of the sheet S.

As illustrated in FIG. 12, the lateral registration detector 211 is supported to rotated in the second direction by the lateral registration movement motor 216 and the lateral registration sensor moving belt 217 as a skew detector mover. The direction and amount of movement of the lateral registration detector 211 is indicated by the sheet binder controller 112.

### Description of Skew Detection Timing

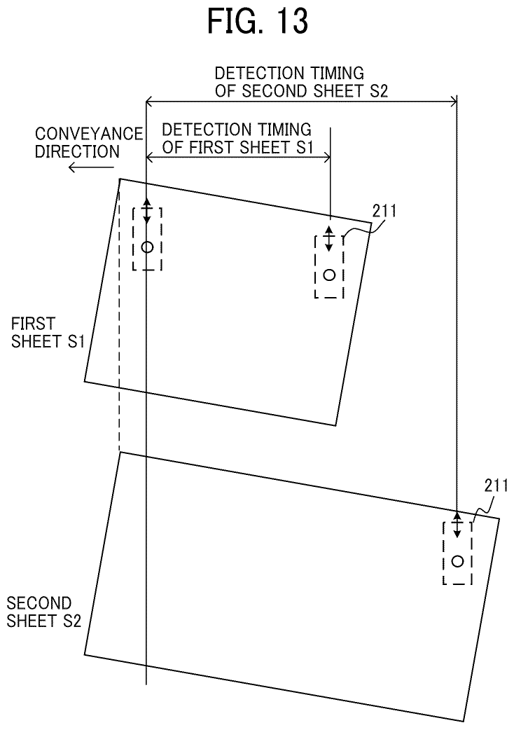

FIG. 13 is a diagram illustrating an execution timing of a skew detecting operation set according to the size of the sheet S.

For example, as illustrated in FIG. 13, a first sheet S1 assumed to have a standard size and a second sheet S2 larger than the first sheet S1 will be used for the description.

As described above, the lateral registration detector 211 is moved to detect the end portion of the sheet S in the width direction near the leading end of the sheet S according to the size (sheet information) of the sheet S, and then detect the end portion of the sheet S in the width direction near the trailing end of the sheet S, based on the position of the trailing end of the sheet S determined according to the size of the sheet S. In other words, the end detection timing in the detection (skew detection) of the end portion of the sheet S by the lateral registration detector 211 can be changed according to the size of the sheet S.

As illustrated in FIGS. 7 to 11, the lateral registration sensor 211a to detect the end of the sheet S by the lateral registration detector 211 is a single sensor.

In FIG. 13, in order to describe the end detection timing, the lateral registration sensor 211a is schematically illustrated near the leading and trailing ends of the sheet S.

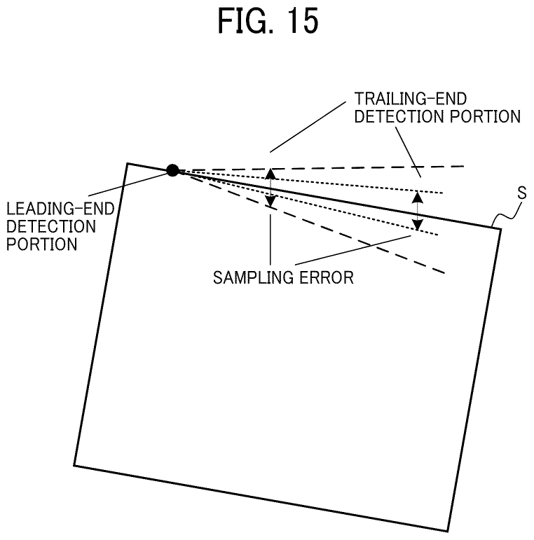

The detection of the end portion of the sheet S in the width direction for skew detection is performed based on the sampling cycle of the lateral registration sensor 211a. In this detection, the deviation from the actual position of the end portion of the sheet S is included. Accordingly, the detection result of the end portion of the sheet S in the width direction in the lateral registration detector 211 includes sampling errors from the sampling by the conveyance speed of the sheet S and the lateral registration sensor 211a (see FIG. 15).

However, the sampling errors do not change regardless of the position in the conveyance direction at which the lateral registration sensor 211a detects the end portion of the sheet S in the width direction.

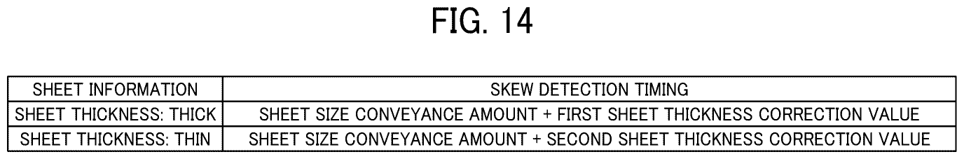

FIG. 14 is a diagram illustrating a table of data configuration indicating an example of sheet information according to the present embodiment.

FIG. 15 is a diagram illustrating a sampling error in the skew detecting operation according to the present embodiment.

As the correlation data between the sheet information and the skew detection timing illustrated in FIG. 14, the accuracy of the skew amount can be enhanced when the skew detection timing is set longer.

Further, the timing of detecting the end portion of the sheet S in the width direction for skew detection is added with a correction value corresponding to the sheet thickness by considering the amount of slip of the sheet S specified by the sheet information based on the data in the table illustrated in FIG. 14. However, since the amount of slip of the sheet S increases as the sheet thickness increases, the relation of the first sheet thickness correction value >the second sheet thickness correction value is satisfied.

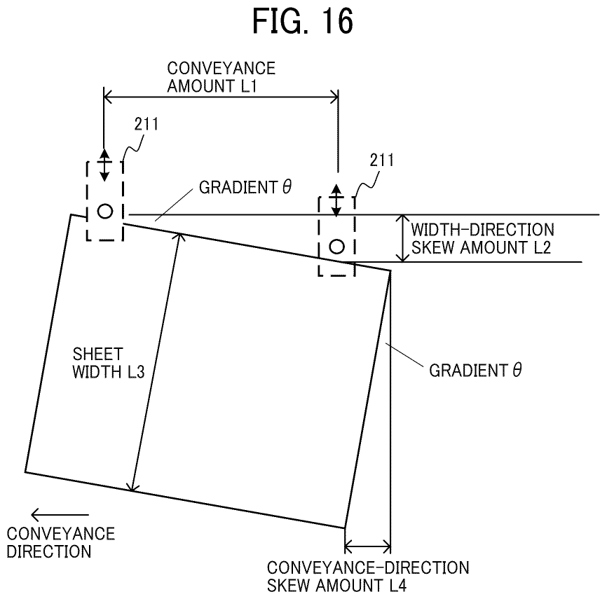

Referring to FIG. 16, a description is given of the detection of skew amount.

FIG. 16 is a diagram illustrating the skew amount in a skew detecting operation according to the present embodiment.

In FIG. 16, the detection interval of the end portion of the sheet S in the width direction by the lateral registration detector 211 is illustrated as a conveyance amount L1. The conveyance amount L1 corresponds to a detection interval from when the lateral registration sensor 211a detects the end portion of the sheet S in the width direction near the leading end of the sheet S to when the lateral registration sensor 211a detects the end portion of the sheet S in the width direction near the trailing end of the sheet S. Accordingly, as the length of the sheet S in the conveyance direction (sheet length) changes, the detection interval changes.

The end portion of the sheet S in the width direction near the leading end of the sheet S and the end portion of the sheet S in the width direction near the trailing end of the sheet S are detected while the sheet S is being conveyed. Then amount of skew of the sheet S during the conveyance of the sheet S can be detected based on the difference between these positions of the end portions of the sheet S in the width direction.

Since the lateral registration detector 211 does not move the position in the conveyance direction (the first direction) of the sheet S, a skew amount L2 in the width direction of the sheet S can be calculated based on the conveyance amount L1 of the sheet S, the conveyance speed of the sheet S and the timing at which the lateral registration detector 211 detects the end portion of the sheet S in the width direction.

Then, a gradient θ with respect to the conveyance direction (the first direction) of the sheet S can be calculated based on the conveyance amount L1 and the skew amount L2. The gradient θ is calculated by “tan⁻¹ (L2/L1)”. This is defined as Equation (1). A conveyance-direction skew amount L4 is calculated by “sheet width L3 sin θ of the sheet S”. This is defined as Equation (2). The conveyance-direction skew amount L4 of the sheet S can be calculated based on Equations (1) and (2) described above. Even if the direction in which the sheet S is skewed is different, the skew amount can be calculated based on Equations (1) and (2) similarly.

### Operation Process of Staple Binding Mode

A description is now given of an operation process of a staple binding mode from the conveyance operation and the binding operation of the sheet S in the sheet binder 110, with reference to multiple drawings.

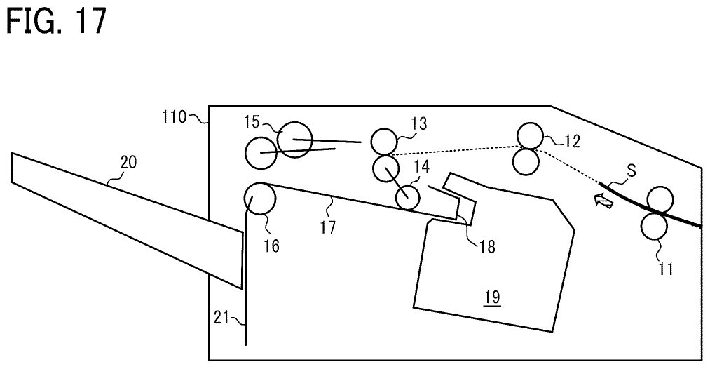

FIG. 17 is a diagram illustrating the sheet binder 110 according to the present embodiment, performing an operation process in which the sheet S is received in the sheet binder 110.

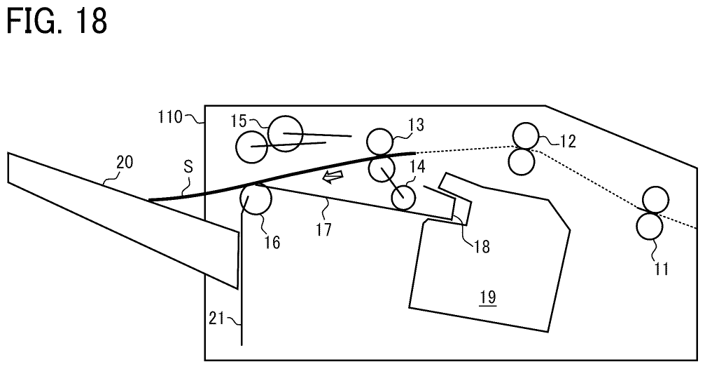

FIG. 18 is a diagram illustrating the sheet binder 110 according to the present embodiment, performing an operation process subsequent to the operation process in FIG. 17.

As illustrated in FIG. 18, since the sheet S is conveyed without shifting the sheet S in the staple binding mode, the ejection driven roller 16b remains at the nip pressure releasing position and the sheet S is conveyed in the first direction.

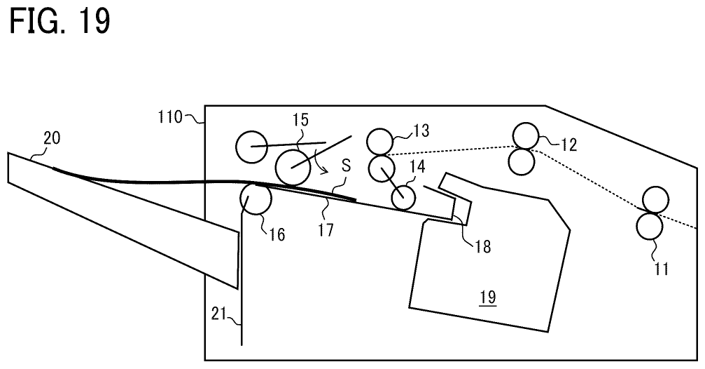

FIG. 19 is a diagram illustrating the sheet binder 110 according to the present embodiment, performing an operation process subsequent to the operation process in FIG. 18.

As illustrated in FIG. 19, the sheet S whose trailing end has passed through the shift roller pair 13 falls onto the sheet tray 17 as an internal tray along with the aid of gravity. Then, the tapping roller 15 comes into contact with the sheet S placed on the sheet tray 17 and conveys the sheet S in the second direction. As a result, the sheet S is conveyed in a manner of switchback conveyance toward the reference fence 18 while being placed on the sheet tray 17.

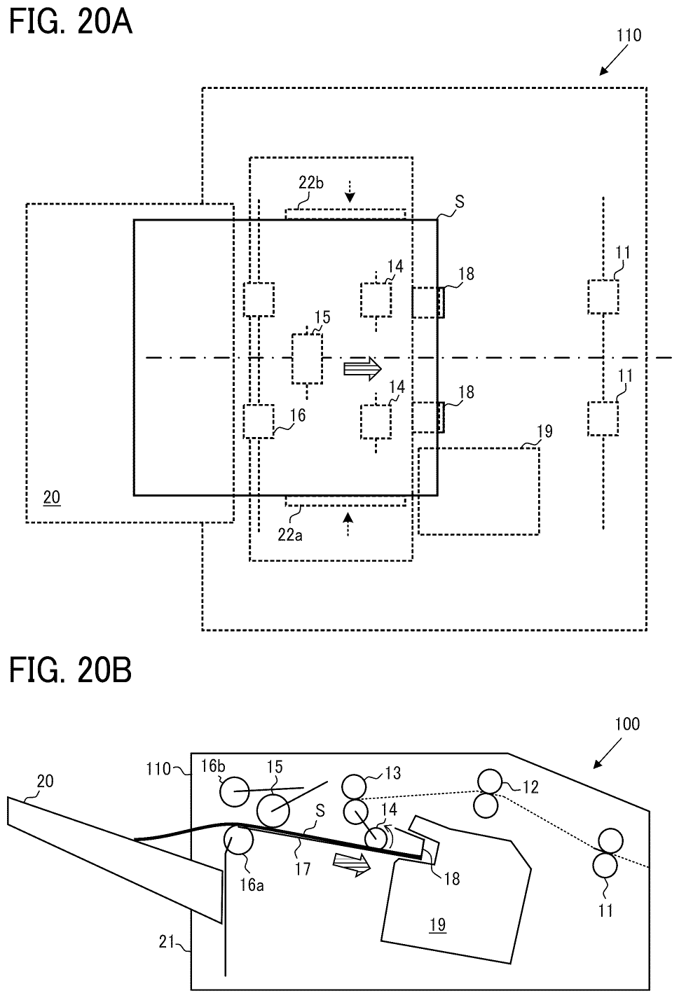

FIGS. 20A and 20B are diagrams illustrating the sheet binder 110 according to the present embodiment, performing an operation process subsequent to the operation process in FIG. 19.

As illustrated in FIGS. 20A and 20B, the sheet S is conveyed due to the switchback conveyance by the tapping roller 15 and the return roller 14 until the end portion of the sheet S contacts the reference fence 18 as a conveyance-direction aligner. The end portion of the sheet S corresponds to the leading end of the sheet S in conveyance in the third direction. After the end portion of the sheet S contacts the reference fence 18, a front side jogger fence 22a and a back side jogger fence 22b, each functioning as a width-direction aligner, sandwich the sheet S so that the end portion of the sheet S in the lateral direction (width direction) contacts the front side jogger fence 22a and the back side jogger fence 22b. The front side jogger fence 22a and the back side jogger fence 22b may be referred to as “jogger fences 22.” Due to this operation, an alignment is performed on the end portions in the width direction of the sheets S stacked on the sheet tray 17.

By repeatedly executing the processes from FIG. 17 to FIGS. 20A and 20B, multiple sheets S are stacked on the sheet tray 17. The number of repetitions corresponds to the number of sheets S included in the sheet bundle Sb.

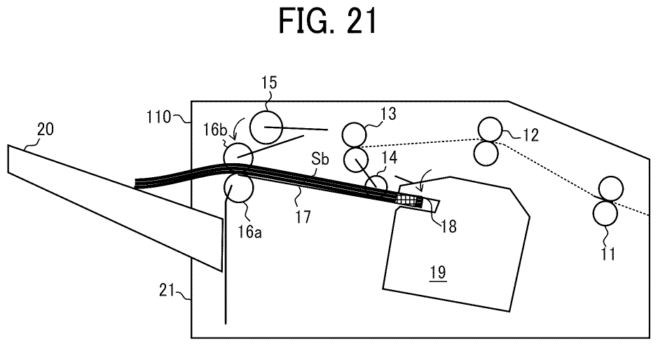

FIG. 21 is a diagram illustrating the sheet binder 110 according to the present embodiment, performing an operation process subsequent to the operation process in FIGS. 20A and 20B.

As illustrated in FIG. 21, after the sheets S are placed on one another (stacked) on the sheet tray 17, the stapler 19 is used to perform the staple binding on a part (of the end portion) of the sheet bundle Sb. When the staple binding is performed, the ejection driven roller 16b moves to the nip position. Then, the sheet bundle Sb is ejected to the ejection tray 20 by the ejection roller pair 16.

### Embodiment of Skew Correction in Sheet Processing Unit 100

A description is given below of the conveyance control based on the conveyance-direction skew amount L4 calculated by the lateral registration detector 211 in the sheet binding operation by the sheet binder 110 described above.

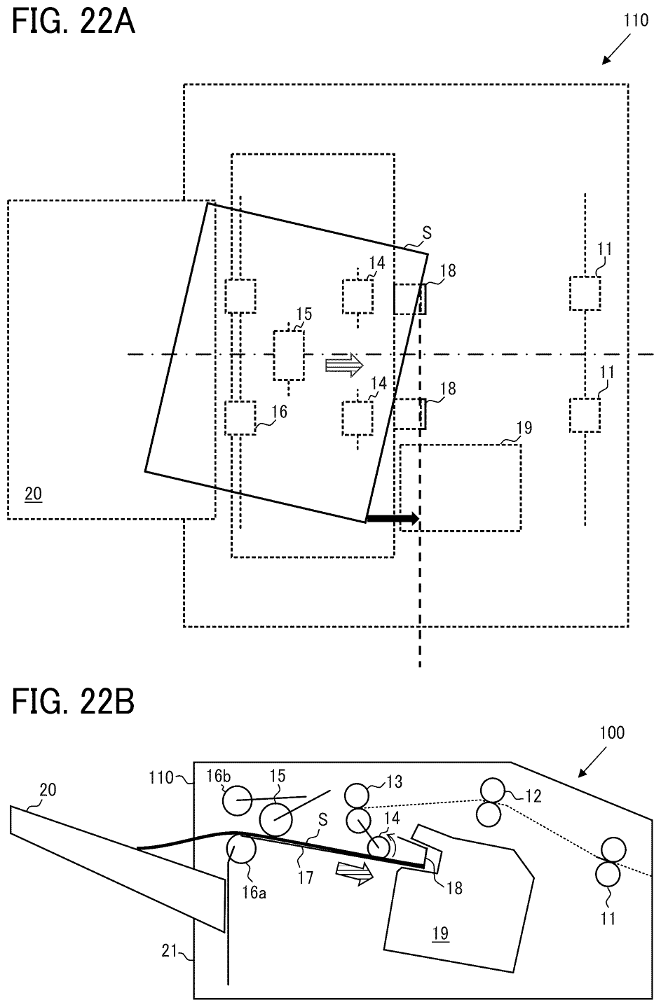

FIGS. 22A and 22B are diagrams illustrating the sheet binder 110 according to the present embodiment, when the sheet S is in the state illustrated in FIGS. 20A and 20B, in the sheet binder 110 with the sheet S being skewed.

When the sheet S is not skewed, the sheet S may be conveyed in the third direction until the sheet S reaches the reference fence 18 as illustrated in FIGS. 20A and 20B. On the other hand, when the sheet S is skewed, as illustrated in FIGS. 22A and 22B, in a case where the conveyance amount of the sheet S in the third direction is set by a default value based on the size of the sheet S, the sheet S reaches the reference fence 18 in a state where the sheet S is skewed.

Even if the skewed sheet S reaches the reference fence 18, the end portion of the sheet S in the conveyance direction cannot be aligned, and the sheet binding operation becomes difficult.

In order to address this state, the conveyance amount by the tapping roller 15 and the return roller 14 is corrected according to the size of the calculated conveyance-direction skew amount L4, and the conveyance control of the sheet S in the third direction is executed. By so doing, the skew of the sheet S is corrected, and the end portion of each sheet S in the conveyance direction is aligned to the reference fence 18 as illustrated in FIGS. 22A and 22B. Accordingly, the sheet binding operation can be performed normally.

### Second Embodiment of Sheet Processing Unit 100

An image forming apparatus 130 as an external device may be coupled to the sheet processing unit 100 to acquire the conveyance timing of the sheet S from the image forming apparatus 130.

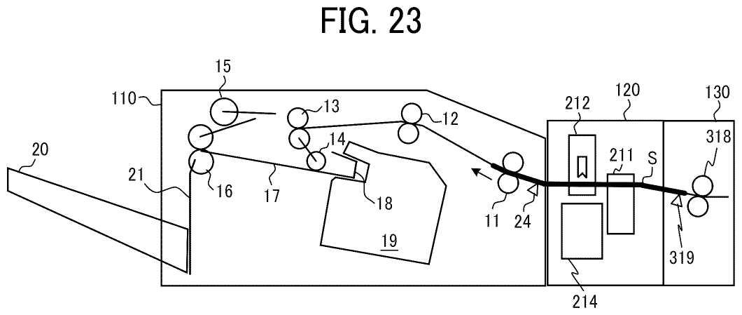

FIG. 23 is a diagram illustrating the sheet processing unit 100 according to the present embodiment, coupled with the image forming apparatus 130 as an external device.

The image forming apparatus 130 includes an image forming apparatus exit roller 318 and an image forming apparatus exit sensor 319.

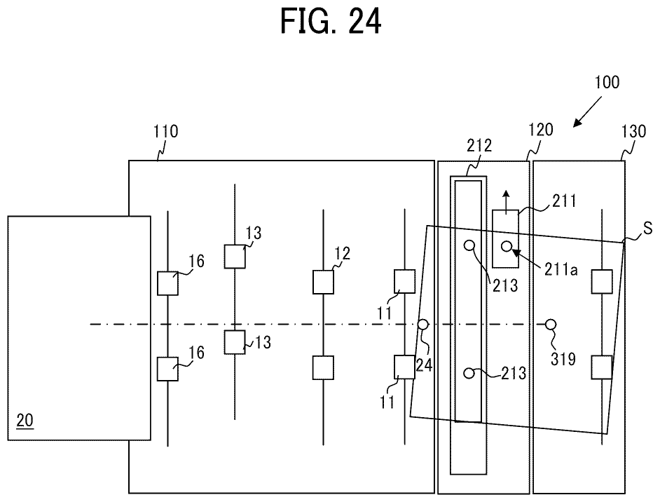

FIG. 24 is a diagram illustrating a coupling operation process of the sheet processing unit 100 according to the present embodiment and the image forming apparatus 130 as an external device.

As illustrated in FIG. 24, the lateral registration detector 211 may not be used but the image forming apparatus exit sensor 319 may be used to detect conveyance of the sheet S to the hole puncher 120. Further, the sheet S may be conveyed in and out by using the entrance sensor 24 provided with the sheet binder 110.

In a case where a detection of conveyance of the sheet S is performed by the image forming apparatus exit sensor 319 disposed upstream from the lateral registration detector 211 in the conveyance direction of the sheet S, the end portion of the sheet S in the width direction near the leading end of the sheet S can be detected more quickly, when compared with a detection of conveyance of the sheet S is performed by the lateral registration sensor 211a of the lateral registration detector 211. In other words, since the lateral registration sensor 211a can be moved in a direction toward the end portion of the sheet S in the width direction without waiting for a detection of the leading end of the sheet S at the position corresponding to the one fourth of the width of the sheet S, even when the conveyance speed of the sheet S is relatively fast, the end portion of the sheet S in the width direction can be detected with higher accuracy, and the skew amount of the sheet S can be calculated accurately.

### Embodiment of Hole Puncher 120

A description is given below of the hole puncher 120 as a punching unit according to an embodiment of the present disclosure, with reference to FIG. 25.

FIG. 25 is a diagram illustrating a schematic configuration of the hole puncher 120 according to the present embodiment.

The hole puncher 120 performs a punching operation on a sheet S each time the sheet S is conveyed. In a case where the punching operation is performed with the sheet S being skewed, the holes are formed at incorrect positions.

In order to avoid such a situation, the lateral registration detector 211 is disposed upstream from the hole puncher 120 in the conveyance direction of the sheet S, to calculate in advance the conveyance-direction skew amount L4 related to the sheet S to be conveyed toward the hole puncher 120. Depending on the conveyance-direction skew amount L4, one side of the punching device 212 is moved in the first direction or the third direction using the hole puncher adjustment motor 218. With this operation, the skew correction is performed in the hole punching to form (punch) a hole or holes. The hole puncher 120 can change the angle of the hole puncher 120 in the longitudinal direction with respect to the first direction.

According to the sheet processing unit 100 described above, the skew detection is performed in accordance with the size of the sheet S, so that the accuracy of the skew detection can be maintained even in a case where the sheet S having a large size.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Aspects of the present disclosure are, for example, as follows.

### Aspect 1

In Aspect 1, a sheet conveying device includes conveyors, a skew detector, a skew detector mover, and a controller. The conveyors convey a sheet medium. The skew detector detects an amount of skew of the sheet medium to be conveyed by the conveyors in a first direction. The skew detector mover moves the skew detector in a second direction orthogonal to the first direction. The controller controls operations of the conveyors, the skew detector, and the skew detector mover. The controller controls the skew detector mover according to a size of the sheet medium, and changes a detection interval to detect an end of the sheet medium in the second direction by the skew detector.

### Aspect 2

In Aspect 2, in the sheet conveying device according to Aspect 1, the controller is further to change a standby position at which the skew detector detects an end of the sheet medium in the second direction, according to the size of the sheet medium.

### Aspect 3

In Aspect 3, in the sheet conveying device according to Aspect 1 or Aspect 2, the controller is further to move the skew detector to a non-detection position of the sheet medium by the skew detector in the detection interval from when the skew detector detects an end of the sheet medium in the second direction near a leading end of the sheet medium in the first direction to when the skew detector detects an end of the sheet medium in the second direction near a trailing end of the sheet medium in the first direction.

### Aspect 4

In Aspect 4, in the sheet conveying device according to Aspect 3, the controller is further set the detection interval based on reference information related to a size or a thickness of the sheet medium.

### Aspect 5

In Aspect 5, in the sheet conveying device according to any one of Aspects 1 to 4, the skew detector detects a leading end of the sheet medium in the first direction before detecting an end of the sheet medium in the second direction.

### Aspect 6

In Aspect 6, in the sheet conveying device according to any one of Aspects 1 to 5, the conveyors include a first conveyor and a switchback conveyor. The first conveyor conveys the sheet medium in the first direction. The switchback conveyor conveys the sheet medium in an opposite direction to the first direction. The controller is further to control operations of the first conveyor and the second conveyor, and set an amount of conveyance of the sheet medium by the second conveyor according to the amount of skew of the sheet medium detected by the skew detector.

### Aspect 7

In Aspect 7, in the sheet conveying device according to any one of Aspects 1 to 6, the controller is further to move the skew detector to a position detectable of an end of the sheet medium in the second direction near a leading end of the sheet medium in the first direction, based on a conveyance timing of the sheet medium informed by an external device.

### Aspect 8

In Aspect 8, the sheet conveying device according to any one of Aspects 1 to 7 further includes a puncher that is supported to be rotatable with respect to an axis in the second direction, to perform a punching process on the sheet medium. The controller is further to change an angle of rotation of the puncher according to the amount of skew of the sheet medium.

### Aspect 9

In Aspect 9, an image forming system includes a housing, an image forming apparatus included in the housing to form an image on a sheet medium, and the sheet conveying device according to any one of Aspects 1 to 8. The sheet conveying device is detachably attached to the housing to convey the sheet medium having the image formed by the image forming apparatus.

### Aspect 10

In Aspect 10, a sheet conveying device includes conveyors, a skew detector, a mover, and circuitry. The conveyors convey a sheet medium in a first direction. The skew detector detects an amount of skew of the sheet medium conveyed by the conveyors in the first direction. The mover moves the skew detector in a second direction orthogonal to the first direction. The circuitry is to control the mover to move the skew detector in the second direction to detect, multiple times, an end of the sheet medium in the second direction at a detection interval, and change the detection interval of multiple detections according to a size of the sheet medium, to detect the amount of skew of the sheet medium.

### Aspect 11

In Aspect 11, in the sheet conveying device according to Aspect 10, the skew detector detects the end of the sheet medium in the second direction at a standby position, the standby position is a position to start moving in the second direction for detecting the end and is changed according to the size of the medium, and the circuitry is further configured to change the standby position according to the size of the sheet medium.

### Aspect 12

In Aspect 12, in the sheet conveying device according to Aspect 10 or Aspect 11, the skew detector does not detect the sheet medium at a non-detection position in the second direction. The circuitry is further to set the detection interval: from when the skew detector detects an end of the sheet medium in the second direction near a leading end of the sheet medium in the first direction; to when the skew detector detects an end of the sheet medium in the second direction near a trailing end of the sheet medium in the first direction, and move the skew detector to the non-detection position during the detection interval.

### Aspect 13

In Aspect 13, in the sheet conveying device according to Aspect 12, the circuitry is further to set the detection interval based on reference information related to the size or a thickness of the sheet medium.

### Aspect 14

In Aspect 14, in the sheet conveying device according to Aspect 12, the circuitry is further to set a conveyance amount of the sheet medium in the first direction by the conveyors based on the size of the sheet medium, and set the detection interval based on the conveyance amount.

### Aspect 15

In Aspect 15, in the sheet conveying device according to any one of Aspects 10 to 14, the skew detector detects a leading end of the sheet medium in the first direction before detecting the end of the sheet medium in the second direction.

### Aspect 16

In Aspect 16, in the sheet conveying device according to any one of Aspects 10 to 15, the conveyors include a first conveyor to convey the sheet medium in the first direction, and a second conveyor to switchback and convey the sheet medium in a third direction opposite to the first direction. The circuitry is further to set an amount of conveyance of the sheet medium by the second conveyor according to the amount of skew of the sheet medium detected by the skew detector, and control the first conveyor and the second conveyor to convey the sheet medium in the first direction and the third direction, respectively.

Aspect 17 In Aspect 17, in the sheet conveying device according to any one of Aspects 10 to 16, the circuitry is further to, in response to a notification of a conveyance timing of the sheet medium from an external device, control the mover to move the skew detector to detect the end of the sheet medium in the second direction near a leading end of the sheet medium in the first direction.

### Aspect 18

In Aspect 18, the sheet conveying device according to any one of Aspects 10 to 17 further includes a puncher to perform a punching process on the sheet medium. The puncher is changeable of an angle in a longitudinal direction with respect to the first direction. The circuitry is further to change the angle of the puncher according to the amount of skew of the sheet medium.

### Aspect 19

In Aspect 18, an image forming system includes an image forming apparatus that includes a housing, an image forming device in the housing to form an image on a sheet medium, and the sheet conveying device according to any one of Aspects 10 to 18, detachably attached to the housing to convey the sheet medium having the image formed by the image forming device.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A sheet conveying device comprising:
conveyors to convey a sheet medium in a first direction;
a skew detector to detect an amount of skew of the sheet medium conveyed by the conveyors in the first direction;
a mover to move the skew detector in a second direction orthogonal to the first direction; and
circuitry configured to:
control the mover to move the skew detector in the second direction to detect, multiple times, an end of the sheet medium in the second direction at a detection interval; and
change the detection interval of multiple detections according to a size of the sheet medium,
to detect the amount of skew of the sheet medium.

2. The sheet conveying device according to claim 1,
wherein the skew detector detects the end of the sheet medium in the second direction at a standby position,
the standby position is a position to start moving in the second direction for detecting the end and is changed according to the size of the medium, and
the circuitry is further configured to change the standby position according to the size of the sheet medium.

3. The sheet conveying device according to claim 1,
wherein the skew detector does not detect the sheet medium at a non-detection position in the second direction,
the circuitry is further configured to:
set the detection interval:
from when the skew detector detects an end of the sheet medium in the second direction near a leading end of the sheet medium in the first direction;
to when the skew detector detects an end of the sheet medium in the second direction near a trailing end of the sheet medium in the first direction; and
move the skew detector to the non-detection position during the detection interval.

4. The sheet conveying device according to claim 3,
wherein the circuitry is further configured to set the detection interval based on reference information related to the size or a thickness of the sheet medium.

5. The sheet conveying device according to claim 3,
wherein the circuitry is further configured to:
set a conveyance amount of the sheet medium in the first direction by the conveyors based on the size of the sheet medium; and
set the detection interval based on the conveyance amount.

6. The sheet conveying device according to claim 1,
wherein the skew detector detects a leading end of the sheet medium in the first direction before detecting the end of the sheet medium in the second direction.

7. The sheet conveying device according to claim 1,
wherein the conveyors include:
a first conveyor to convey the sheet medium in the first direction; and
a second conveyor to switchback and convey the sheet medium in a third direction opposite to the first direction, and
the circuitry is further configured to:
set an amount of conveyance of the sheet medium by the second conveyor according to the amount of skew of the sheet medium detected by the skew detector; and
control the first conveyor and the second conveyor to convey the sheet medium in the first direction and the third direction, respectively.

8. The sheet conveying device according to claim 1,
wherein the circuitry is further configured to:
in response to a notification of a conveyance timing of the sheet medium from an external device,
control the mover to move the skew detector to detect the end of the sheet medium in the second direction near a leading end of the sheet medium in the first direction.

9. The sheet conveying device according to claim 1, further comprising a puncher to perform a punching process on the sheet medium,
wherein the puncher is changeable of an angle in a longitudinal direction with respect to the first direction, and
the circuitry is further configured to change the angle of the puncher according to the amount of skew of the sheet medium.

10. An image forming system comprising:
an image forming apparatus including:
a housing; and
an image forming device in the housing to form an image on a sheet medium; and
the sheet conveying device according to claim 1, detachably attached to the housing to convey the sheet medium having the image formed by the image forming device.
